(19) United States
(12) Patent Application Publication
(10) Pub. No.: US 2008/0041974 A1
(43) Pub. Date: Feb. 21, 2008

(54) Fuel Injection Device

(75) Inventors: Koji Ishibashi, Toyota-shi (JP); Takeshi Kitamura, Toyota-shi (JP); Osamu Nishimura, Chiryu-shi (JP); Kiyomi Kawamura, Nisshin-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/663,173

(22) PCT Filed: Sep. 22, 2005
(86) PCT No.: PCT/JP05/17448

§ 371 Date: Mar. 19, 2007

(30) Foreign Application Priority Data
Sep. 22, 2004 (JP) 2004-276205
May 9, 2005 (JP) 2005-135643

(51) Int. Cl. B05B 1/34

(52) U.S. Cl. 239/487

(57) ABSTRACT

A fuel injection device 1A includes a nozzle body 10 equipped with multiple injection apertures 12, a needle valve 20 arranged in the nozzle body, a fuel swirl portion 24 in which fuel FE is swirled along an inner wall surface of the nozzle body, and a guide portion 22 applying swirl force to the fuel and then guiding the fuel to the fuel swirl portion, the fuel swirl portion being arranged at a position at which the fuel swirl portion partially overlaps with the injection apertures. When the needle valve is at a low lift position, the fuel swirl portion overlaps with parts of the injection apertures so that the shape of sprayed fuel can be formed in diffusive spray having a wide spray angle. When the needle valve is at a high lift position, the shape of sprayed fuel can be formed in column-shaped spray having a narrow spray angle.

### TECHNICAL FIELD

The present invention relates to a fuel injection device used in an internal combustion engine, and more particularly, to a fuel injection device capable of forming diffusive spray and changing the spray shape.

### BACKGROUND ART

Recently, there has been considerable activity in the technique of changing the sprayed shape of fuel injected through an injection aperture on the basis of the load state of an internal combustion engine such as a diesel engine or a gasoline engine. The optimized shape of sprayed fuel based on the load state of the internal combustion engine improves fuel economy and exhaust emission.

For example, Patent Document 1 discloses a fuel injection device with a swirl flow forming member and a cylindrical forming room, which are located an upstream side of a seat portion located between a needle valve and a nozzle body. The device alters the lift amount of the needle valve on the basis of the load state of the internal combustion engine to thus adjust the degree of opening in a fuel inlet passage connected to the swirl flow forming room. It is thus possible to change the shape of sprayed fuel injected via an injection aperture formed in a lower end of the nozzle body.
Patent Document 1: Japanese Patent Application Publication No. 2000-145584

### DISCLOSURE OF THE INVENTION

### PROBLEMS TO BE SOLVED BY THE INVENTION

However, the device disclosed in Patent Document 1 needs a particular member (swirl flow forming member) for forming swirl flow arranged between the needle valve and the nozzle body, and thus has a complicated structure. Further, the device shown in Patent Document 1 has the single injection aperture provided in the lower end of the nozzle body. Patent Document 1 does not disclose any technique of controlling the shape of spayed fuel injected via multiple injection apertures provided on a side of the nozzle body.

An object of the present invention is to provide a fuel injection device having a simple structure equipped with multiple injection apertures via which fuel is diffusively spayed and capable of changing the shape of sprayed fuel.

### MEANS FOR SOLVING THE PROBLEMS

The above object is achieved by a fuel injection device characterized by comprising a nozzle body equipped with multiple injection apertures, a needle valve arranged in the nozzle body, a fuel swirl portion in which fuel is swirled along an inner wall surface of the nozzle body, and a guide portion applying swirl force to the fuel and then guiding the fuel to the fuel swirl portion, the fuel swirl portion being arranged at a position at which the fuel swirl portion partially overlaps with the injection apertures.

The fuel swirl portion may include a first circumferential groove formed on one of the inner wall surface of the nozzle body and an outer circumferential surface of the needle valve. The guide portion may include a groove formed on the inner wall surface of the nozzle body and an outer circumferential surface of the needle valve.

A protrusion may be provided at an upstream side of the circumferential groove, and the guide grooves are formed in the protrusion. Another protrusion may be provided at a downstream side of the circumferential groove.

There may be provided a needle movement mechanism that moves the needle valve in its axial direction to thus change a lift amount of the needle valve, wherein: the needle valve is movable between a low lift position having a small lift amount and a high lift position having a large lift amount by the needle movement mechanism; and the first circumferential groove overlaps with parts of injection apertures when the needle valve is located at the low lift position.

The fuel swirl portion may include a ring-shaped s pacing formed between an outer circumferential surface of the needle valve and the inner wall surface of the nozzle body. The guide portion may include a groove formed on one of the inner wall surface of the nozzle body and the outer circumferential surface of the needle valve. There may be provided a needle movement mechanism that moves the needle valve in its axial direction to thus change a lift amount of the needle valve, wherein: the needle valve is movable between a low lift position having a small lift amount and a high lift position having a large lift amount by the needle movement mechanism; and a ring-shaped spacing is defined when the needle valve is at the low lift position.

The needle valve may have a column-shaped portion having a small size at a tip, and the ring-shaped spacing may be defined between the outer circumferential surface of the column-shaped portion and the inner wall surface of the nozzle body when the needle valve is at the low lift position. The protrusion may be at an upstream side of the column-shaped portion, and a groove included in the guide portion may be formed in the protrusion.

A second circumferential groove for rectification may be connected to an upstream side of the guide portion.

A swirl flow forming member may be provided so as to be spaced apart from the fuel swirl portion, wherein the swirl flow forming member has the guide portion. The fuel swirl portion may be a first circumferential groove formed on one of the inner wall surface of the nozzle body and an outer circumferential surface of the needle valve. A protrusion may be provided at a downstream side of the first circumferential groove. There may be provided a characterized by further comprising a needle movement mechanism that moves the needle valve in its axial direction to thus change a lift amount of the needle valve, wherein: the needle valve is movable between a low lift position having a small lift amount and a high lift position having a large lift amount by the needle movement mechanism; and the first circumferential groove overlaps with parts of injection apertures when the needle valve is located at the low lift position.

The guide portion may include a groove, which includes a groove width at a fuel inlet side greater than a groove width at a fuel outlet side. The guide portion may include a groove, which gradually becomes deeper from an upstream side in a fuel swirl direction to a downstream side.

The first circumferential groove may have a cross section taken along an axial line of the needle valve so that the cross section has a depth that gradually increases from a tip of the needle valve to a root end of the needle valve. The first circumferential groove may have a cross section taken along an axial line of the needle valve so that the cross section has a depth that gradually increases from a root end of the needle valve to a tip of the needle valve.

### EFFECTS OF THE INVENTION

According to the present invention, the fuel swirl portion that swirls fuel is arranged so as to overlap with parts of the injection apertures, so that the spay of sprayed fuel can be formed into diffusive spray having a wide spray angle. When the fuel swirl portion becomes away from the injection apertures, the shape of sprayed fuel can be formed into column-shaped spray having a narrow spray angle. It is thus possible to change the shape of sprayed fuel only be adjusting the positional relationship between the fuel swirl portion and the injection apertures.

### BRIEF DESCRIPTION OF THE DRAWINGS

FIG. 1 is an enlarged view of a peripheral portion of injection apertures of a fuel injection device 1A in accordance with Embodiment 1;

FIG. 2 schematically shows a change of the sprayed shape observed when the lift amount of a needle valve of the fuel injection device 1A;

FIG. 3(A) schematically shows a positional relationship between a circumferential groove and an inlet portion of an injection aperture at the time of low lift; FIG. 3(B) schematically shows the positional relationship between the circumferential groove and the inlet portion of the injection aperture;

FIG. 4 is a cross-sectional view of the fuel injection device 1A illustrated so as to facilitate visual confirmation of a needle movement mechanism;

FIG. 5 is an enlarged view of a peripheral portion of injection apertures of a fuel injection device 1B in accordance with Embodiment 2;

FIG. 6 is an enlarged view of a peripheral portion of injection apertures of a fuel injection device 1C in accordance with Embodiment 3;

FIG. 7 is an enlarged view of a peripheral portion of injection apertures of a fuel injection device 1D in accordance with Embodiment 4;

FIG. 8 is an enlarged view of a peripheral portion of injection apertures of a fuel injection device 1E in accordance with Embodiment 5;

FIG. 9 is an enlarged view of the peripheral portion of injection apertures of the fuel injection device 1E in accordance with Embodiment 5;

FIG. 10 is an enlarged view of a peripheral portion of injection apertures of a fuel injection device 1F in accordance with Embodiment 6;

FIG. 11 is an enlarged view of a peripheral portion of injection apertures of a fuel injection device 1G in accordance with Embodiment 7;

FIGS. 12(A) and 12(B) are diagrams for explaining differences between the fuel injection devices of different embodiments

FIG. 13 is an enlarged view of a peripheral portion of injection apertures of a fuel injection device 1H in accordance with Embodiment 8;

FIGS. 14(A) and 14(B) are diagrams illustrating a peripheral portion of injection apertures of a fuel injection device 1I in accordance with Embodiment 9;

FIGS. 15(A) and 15(B) are diagrams illustrating a peripheral portion of injection apertures of a fuel injection device 1J in accordance with Embodiment 10;

FIGS. 16(A) and 16(B) are diagrams illustrating a peripheral portion of injection apertures of a fuel injection device 1K in accordance with Embodiment 11;

FIG. 17 is an enlarged view of a peripheral portion of injection apertures of a fuel injection device 1L in accordance with Embodiment 12;

FIGS. 18(A) and 18(B) are diagrams of variations of guide grooves provided in a needle valve;

FIG. 19(A) and 19(B) are diagrams of variations of guide grooves provided in a needle valve with a protrusion;

FIGS. 20(A) and 20(B) are diagrams of variations of the cross sections of guide grooves in a needle valve; and

FIGS. 21(A), 21(B) and 21(C) are diagrams of variations of the cross sections of circumferential in a needle valve.

### BEST MODES FOR CARRYING OUT THE INVENTION

A description will now be given, with reference to the accompanying drawings, of multiple embodiments of the present invention.

### Embodiment 1

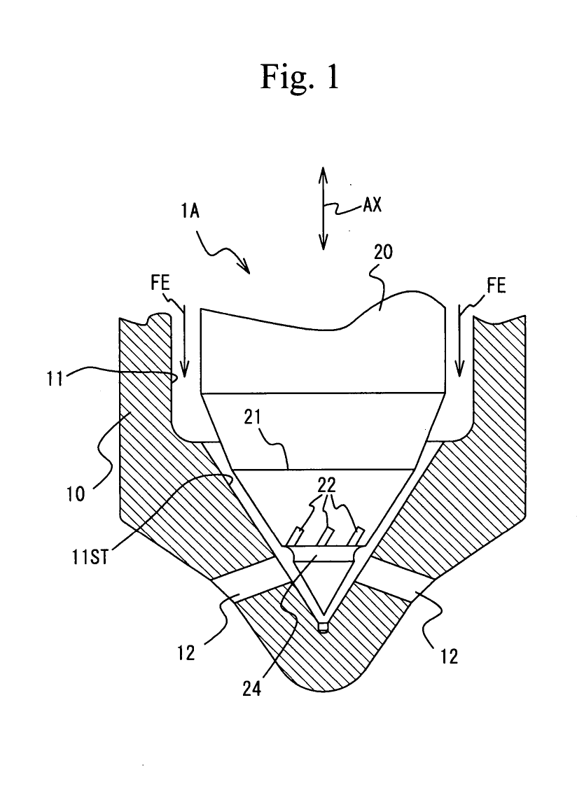

FIG. 1 is an enlarged diagram of a peripheral portion of injection aperture of a fuel injection device 1A in accordance with Embodiment. A fuel injection device 1A includes a nozzle body 10 having an approximately cylindrical space defined inside, and a needle valve 20 provided in the nozzle body 10 and arranged reciprocally in axial directions AX.

A tip (a lower side in FIG. 1) of the nozzle body 10 located on the nozzle side is formed into an approximately conical shape. Thus, an inner wall surface 11 of the nozzle body 10 has a cylindrical shape on the upper side, and a conical shape at the lower end. An upper-side portion of the conically shaped inner wall surface 11 is a seat surface 11ST on which the needle valve 20 is seated. Injection apertures 12 are formed at positions closer to the tip than the seat surface 11ST. Multiple injection apertures (for example, 6 to 12 apertures) 12 has a radial arrangement. The injection apertures 12 are oriented in the radial directions of the nozzle body 10, and are circumferentially arranged at given intervals.

The tip of the needle valve 20 is formed into a conical shape, which corresponds to the inner wall surface 11 of the nozzle body 10. A seat portion 21 that is seated on the seat surface 11ST of the nozzle body 10 is formed in a tip portion of the conical shape. A closed state is defined when the needle valve 20 descends and the seat portion 21 is brought into contact with the seat surface 11ST. As will be described later, the fuel injection device 1A is equipped with a needle movement mechanism that moves the needle valve in the axial directions AX and changes the magnitude of movement (lift amount) of the needle valve. The following description is given assuming that a low lift position is defined as a position at which the needle valve 20 is moved upwards by a relatively small lift amount by means of the needle movement mechanism, and a high lift position is defined as a position at which the needle valve 20 is moved upwards by a relatively large lift amount.

The needle valve 20 has a fully circumferential groove (first circumferential groove) 24, which is located closer to the tip than the seat portion 21 and functions as a fuel swirling portion. The circumferential groove 24 is formed so as to circularly cut off an outer circumferential surface of the conical shape of the tip of the needle valve 20. Multiple guide grooves 22, which are slant to the axial directions AX, are connected to the upper portion of the circumferential groove 24. The multiple guide grooves 22 apply swirl force to fuel and introduce fuel to the fuel swirling portion. The multiple guide grooves 22 are formed by cutting off the outer circumferential surface of the needle valve 20 in strip fashion, and have lower ends connected to the upper end of the circumferential groove 24.

The circumferential groove 24 is positioned so as to overlap the upper-side portions of the injection apertures 12 (parts of the injection apertures) at the low lift position. That is, the circumferential groove 24 is positioned so as to overlap the upper side portions of the injection apertures 12 at the low lift position when viewed in the height direction along the axial direction AX. Preferably, the circumferential groove 24 is positioned so as to overlap ½ to ⅓ of the injection apertures 12 from the upper side.

When the seat portion 21 of the needle valve 20 is seated on the seat surface 11ST of the nozzle body 10, passages of fuel FE to the injection apertures 12 are closed. When the needle valve 20 moves to the low lift position having a small lift amount from the above position, a slight gap is formed between the inner wall surface 11 of the nozzle body 10 and the needle valve 20. Thus, some of the fuel FE flows into the circumferential groove 24 via the slant guide grooves 22. The slant guide grooves 22 apply swirl force (force for swirling leftwards in FIG. 1) to fuel FE, which is then entered into the circumferential groove 24. In this manner, the guide grooves 22 move the fuel FE in the unified flow direction, the fuel FE entering into the circumferential groove 24. Thus, the swirl flow of the fuel FE is formed in the circumferential groove 24.

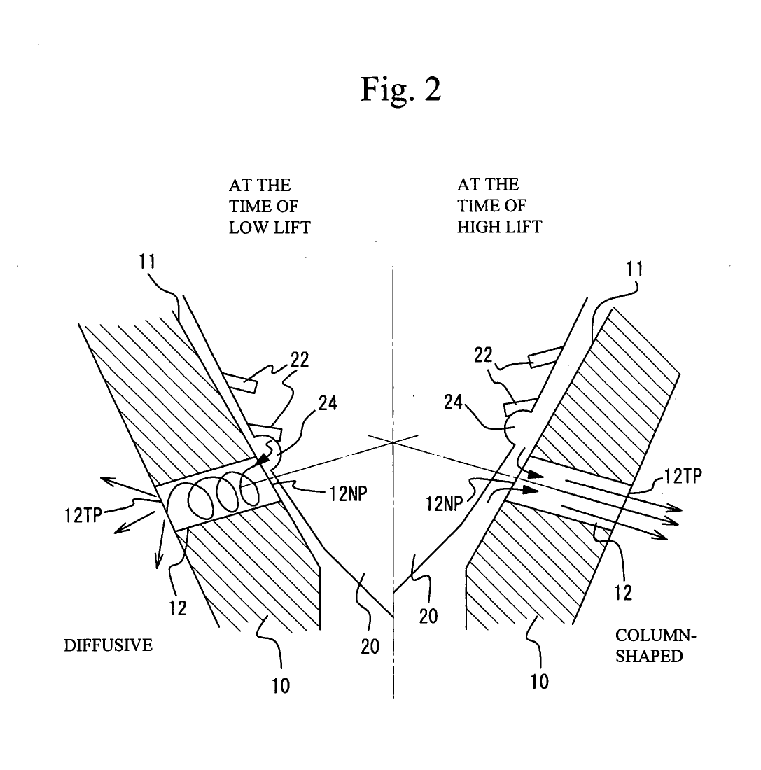

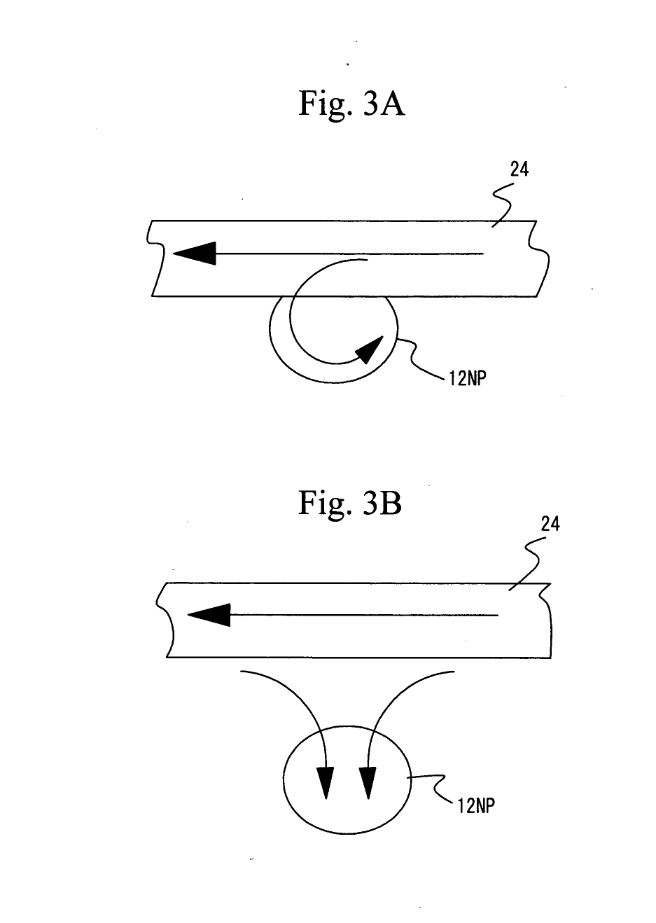

FIG. 2 schematically illustrates a change of the spray shape observed when the lift amount of the needle valve 20 of the fuel injection device 1A is changed. The left side half shows a state at the time of low lift, and the right side half shows a state at the time of high lift. FIG. 3(A) schematically shows a positional relationship between the circumferential groove 24 and an inlet 12NP of the injection aperture 12 at the time of low lift, and FIG. 3(B) schematically shows a positional relationship between the circumferential groove 24 and the inlet 12NP of the injection aperture 12.

As shown in the left side half and FIG. 3(A), the circumferential groove 24 overlaps with an upper portion of the injection inlet 12NP at the time of low lift, and a drift flow is caused when the swirled fuel FE enters into the injection aperture 12. Thus, the fuel discharged from an outlet 12TP of the injection aperture 12 is brought into a state of diffusive spray of fine particles and a wide spray angle. In this manner, the fuel injection device 1A is capable of forming a spray shape of diffusive spray at the low lift position.

In contrast, in the high lift position shown in the right side half of FIG. 2 and FIG. 3(B), the circumferential groove 24 and the guide grooves 22 move to an upper position at which the injection aperture 12 are not affected. At that time, the gap between the needle valve 20 and the inner wall surface 11 of the nozzle body 10 becomes wider, so that an increased amount of fuel FE can enter into the inlet 12NP of the injection aperture 12 without restriction. The fuel FE that has entered into the injection aperture 12 flows towards the outlet 12TP on the straight with little drift flow. Thus, the fuel discharged from the outlet 12TP of the injection aperture 12 has a column-shaped spray having a relatively narrow spray angle.

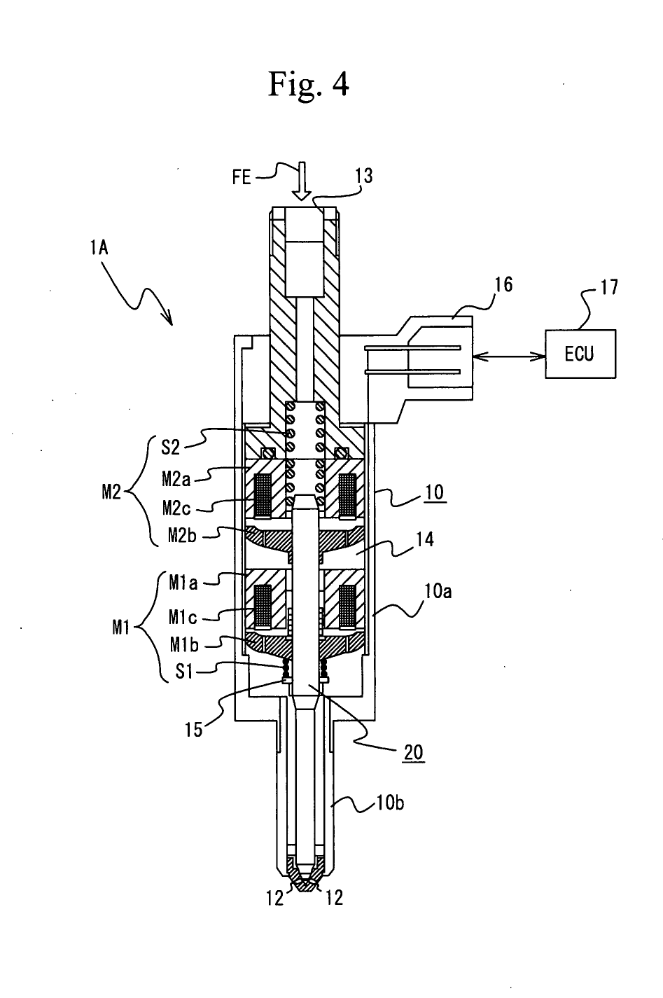

As described above, the fuel injection device 1A enables diffusive spray at the low lift position, and easily changes the spray shape only by changing the lift amount of the needle valve 20. Next, the needle movement mechanism provided in the fuel injection device 1A is described. FIG. 4 is a cross-sectional view of the fuel injection device 1A illustrated so that the needle movement mechanism can be visually confirmed with ease.

The fuel injection device 1A has a fuel feed port 13 that is formed at an upper end and is connected to a not shown fuel pipe. The fuel injection device 1A includes the nozzle body 10 and the needle valve 20 arranged therein, as has been described previously. The nozzle body 10 is made up of a hollow cylindrical main body 10a, and a nozzle portion 10b integrally connected to an end of the main body 10a. The nozzle body 10 internally has a space 14, which continuously extends from the main body 10a to the nozzle portion 10b. The fuel FE entering into the fuel feed port 13 from the fuel pipe moves down in the space 14 and is finally injected via the multiple injection apertures 12 arranged at the lower end.

The needle valve 20 is arranged within the space 14. A first magnetic circuit M1 and a second magnetic circuit M2 are arranged in the space in the main body 10a of the nozzle body 10. The first magnetic circuit M1 has a first electromagnet (M1a, M1c) composed of a first magnetic core M1a of a hollow cylindrical shape and a first coil M1c buried in the first magnetic core M1a. The first magnetic circuit M1 is equipped with a ring-shaped magnetic body (armature) M1b. The needle valve 20 is positioned in an opening of the armature M1b with relative movement. The armature M1b is connected to a stopper member 15 fixed to the needle valve 20 via a first spring S1, and is elastically coupled with the needle valve 20.

The second magnetic circuit M2 having the same configuration as that of the first magnetic circuit M1 is provided at the upper side of the first magnetic circuit M1. The second magnetic circuit M2 has a second electromagnet (M2a, M2c) composed of a second magnetic core M2a of a hollow cylindrical shape and a second coil M2c buried in the second magnetic core M2a. The second magnetic circuit M2 is equipped with a ring-shaped magnetic body (armature) M2b. The needle valve 20 is fixed in an opening of the armature M2b. The armature M2b is elastically coupled with the upper portion of the injector main body 10a via a second spring S2.

The fuel injection device 1A is equipped with a connector 16 for making an electrical connection with an outside thereof. The fuel injection device 1A is connected, via the connector 16, to an ECU (Electronic Control Unit) 17 of a diesel engine on which the fuel injection device 1A is mounted. The fuel injection device 1A is driven under the control of the ECU 17 on the basis of the load state of the diesel engine. When only the first magnetic circuit M1 is driven by the ECU 17, the aforementioned low lift state is realized. When both the first magnetic circuit M1 and the second magnetic circuit M2 are driven by the ECU 17, the aforementioned high lift state is realized.

The fuel injection device 1A with the above-mentioned structure is capable of controlling the shape of sprayed fuel only by forming the circumferential groove 24 and the guide grooves 22 at given positions in the needle valve 20 and moving the needle valve 20 to the low and high lift positions. The fuel injection device 1A of Embodiment 1 may be manufactured at low cost because the grooves are merely formed on the needle valve 20 at given positions.

The above-mentioned fuel injection device 1A may be used in various applications. For example, the fuel injection device 1A may be used to realize an application in which the engine is operated with pre-mixed compression natural ignition combustion in a first operating range having a relative low engine load and is operated with normal combustion (diffusive combustion) in a second operating range having a relatively high engine load. In this application, the needle valve is set at the low lift position in the first operating range so that fuel can be injected with high diffusion and low complete penetration force. In the second operating range, the needle valve is set at the high lift position so that fuel can be injected with low diffusion and high complete penetration force.

The fuel injection device 1A may also be used in another application in which the engine is operated with the pre-mixed compression natural ignition combustion at an initial state of combustion and with the normal combustion at the later stage of combustion. In this application, the needle valve is set at the low lift position in the initial state of combustion so that fuel can be injected with high diffusion and low complete penetration force. In the later stage of combustion, the needle valve is set at the high lift position so that fuel can be injected with low diffusion and high complete penetration force. By spraying fuel in different ways by the fuel injection device 1A as mentioned above, fuel economy can be improved and exhaust emission can be improved.

Preferably, the circumferential groove 24 overlaps with the upper ½ to ⅓ of the injection apertures 12 at the time of low lift. In this case, the circumferential groove 24 may totally or partially overlap with the upper portions of the injection apertures 12.

### Embodiment 2

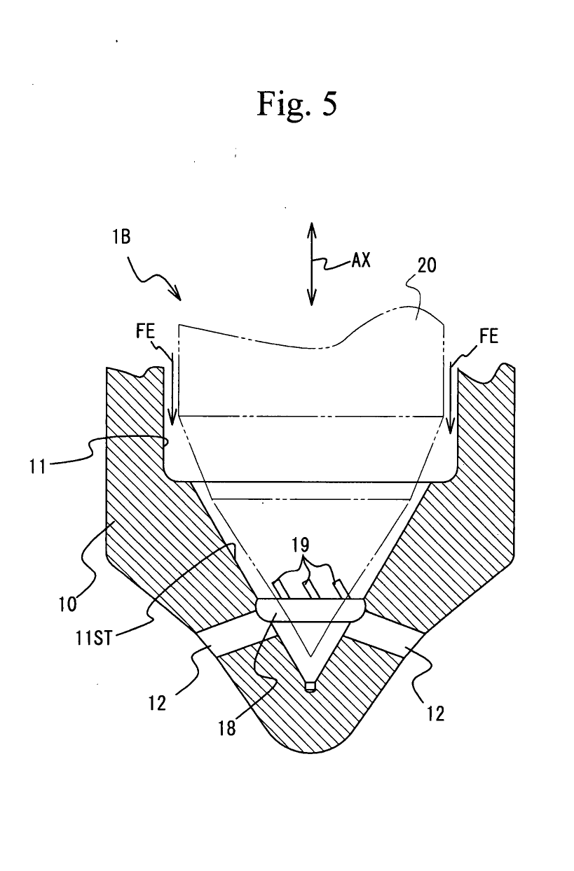

FIG. 5 is an enlarged view of a peripheral portion of the injection apertures of a fuel injection device 1B in accordance with Embodiment 2. Parts that are the same as those of the fuel injection device 1A of Embodiment 1 are given the same reference numerals, and a description thereof will be omitted. In the embodiments described hereinafter, identical parts are given identical numbers and a redundant description thereof will be omitted. The fuel injection device 1B of Embodiment 2 differs in Embodiment 1 in which the circumferential groove 18 and the guide grooves 19 are formed on the inner wall of the nozzle body 10. The circumferential groove 18 is provides so as to partially overlap with the upper portions of the injection apertures 12 at a position lower than the seat surface 11ST. Preferably, the circumferential groove 18 overlap with the upper ½ to ⅓ of the injection apertures. In FIG. 5, the needle valve 20 is depicted by two-dotted chain lines. FIG. 5 shows the circumferential groove 18 and some guide grooves 19 located back from the drawing sheet. The circumferential groove and the guide grooves are not formed on the needle valve 20, which has a uniform outer surface.

Even the fuel injection device 1B of Embodiment 2 brings about advantages similar to those of the fuel injection device 1A. That is, it is possible to easily change the shape of sprayed fuel in such a manner that the circumferential groove 18 and the guide grooves 19 are formed at given positions on the nozzle body 10, and the needle valve 20 is merely moved to the low and high lift positions.

Embodiment 1 has an exemplary structure in which the circumferential groove and the guide grooves are formed on the needle valve, and Embodiment 2 ahs an exemplary structure in which the circumferential groove an the guide grooves are formed on the inner wall of the nozzle body 10. However, the formation of the circumferential groove and the guide grooves are not limited to the above structures. The circumferential groove may be formed on the needle valve 20 and the guide grooves may be formed on the inner wall of the nozzle body 10. In contrast,, the guide grooves may be formed on the needle valve 20, and the circumferential groove may be formed on the inner wall of the nozzle body 10. That is, the circumferential groove and the guide grooves are not formed on the same surface but may be separately formed on the needle valve 20 and the inner wall of the nozzle body 10.

### Embodiment 3

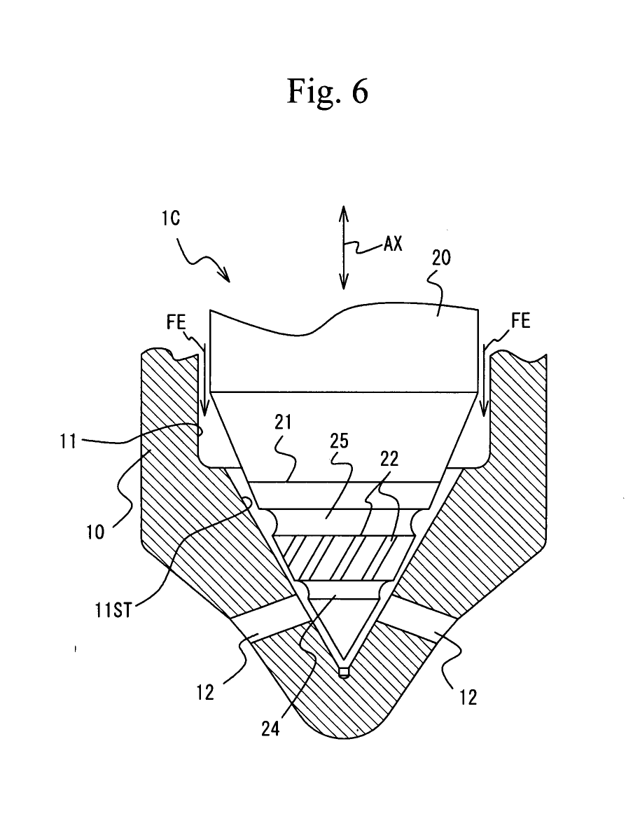

FIG. 6 is an enlarged view of a peripheral portion of injection apertures of a fuel injection device 1C in accordance with Embodiment 3. The fuel injection device 1C of Embodiment 3 has a first circumferential groove that is the aforementioned circumferential groove 24, and a second circumferential groove 25 located between the seat portion 21 and the guide grooves 22. As has been described previously, the first circumferential groove 24 is formed to realize diffusive spray of fuel at the time of low lift. In contrast, the second grooves 25 are formed to efficiently introduce fuel FE to the guide grooves 22. The first circumferential groove 24 and the second circumferential groove 25 are connected via the guide grooves 22.

The fuel FE that unevenly drops from the upstream side of the fuel injection device 1C flows into the guide grooves 22 via the second circumferential groove 25. The fuel FE in the circumferential groove 25 is temporarily reserved therein, and has restored pressure (the liquid phase is homogenized). The multiple guide grooves 22 are connected to the lower side of the second circumferential groove 25. Thus, the fuel FE that is rectified within the second circumferential groove 25 evenly flows into the multiple guide grooves 22. Since the fuel evenly flows into the multiple guide grooves 22, the fuel FE can be smoothly introduced to the first circumferential groove 24 from the guide grooves 22. The use of the circumferential groove 25 having the rectifying function allows the guide grooves 22 to be formed with a slightly lowered precision in processing. It is thus possible to employ plastic forming such as rolling and improve the productivity.

The fuel injection device 1C of Embodiment 3 provides effects similar to those of the fuel injection device 1A. That is, the shape of sprayed fuel can be changed by merely moving the needle valve 20 to the low and high lift positions. Particularly, the fuel injection device 1C is so configured that the fuel FE is rectified in the second circumferential groove 25 and is introduced into the guide grooves 22. It is thus possible to form the guide grooves 22 with a lowered precision.

### Embodiment 4

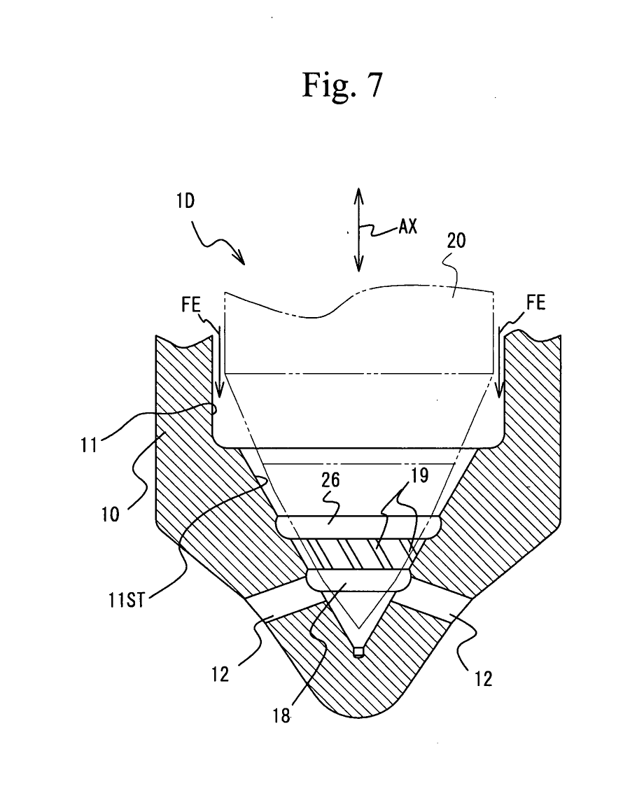

FIG. 7 is an enlarged view of a peripheral portion of injection apertures of the fuel injection device 1D in accordance with Embodiment 4. The fuel injection device 1D of Embodiment 4 corresponds to a combination of the fuel injection device 1B of Embodiment 2 and the fuel injection device 1C of Embodiment 3. More particularly, the first circumferential groove 18, the guide grooves 19 and the second circumferential groove 26 are formed on the inner wall of the nozzle body 10. In FIG. 7, the needle valve 20 is depicted by two-dotted chain lines. FIG. 7 shows the first circumferential groove 18, some guide grooves 19 and the second circumferential groove 26 located back from the drawing sheet. The circumferential groove and the guide grooves are not formed on the needle valve 20, which has a uniform outer surface. The fuel injection device 1D of Embodiment 4 has effects similar to those of the fuel injection device 1C of Embodiment 3.

Embodiment 3 has an exemplary structure in which the first circumferential groove, guide grooves and second circumferential groove are formed on the needle valve 20, and Embodiment 4 has an exemplary structure in which the first circumferential groove, guide grooves and second circumferential groove are formed on the inner wall of the nozzle body 10. However, the formation of the first circumferential groove, guide grooves and second circumferential groove is not limited to the above. For example, the first circumferential groove, guide grooves and second circumferential groove are not required to be formed on an identical surface, but may be separately formed on the needle valve 20 and the inner wall of the nozzle body 10.

### Embodiment 5

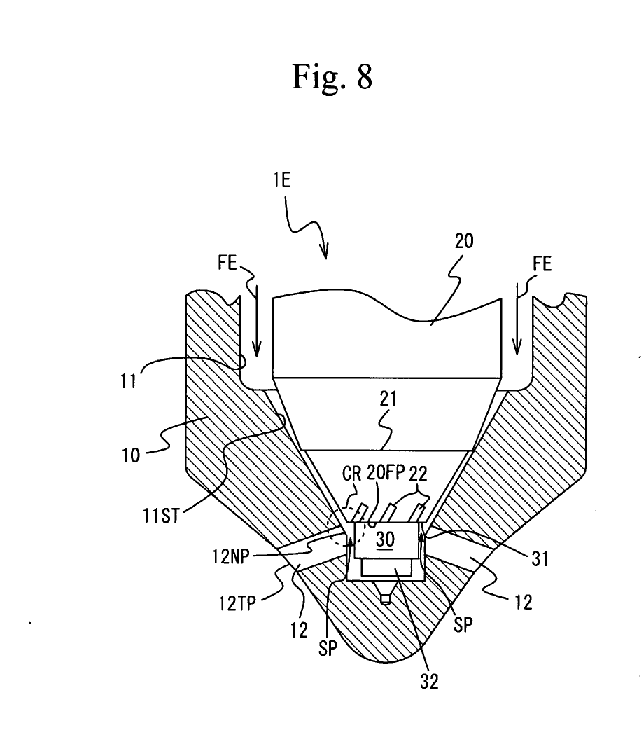

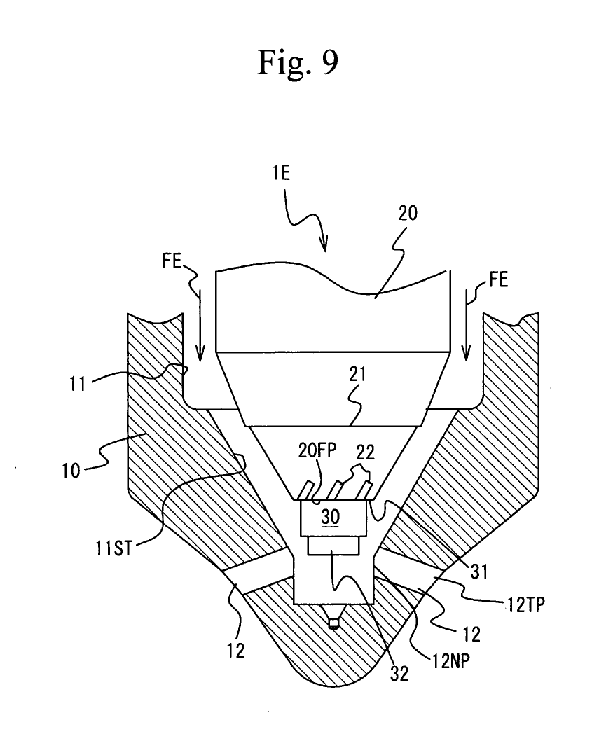

FIGS. 8 and 9 are enlarged views of a peripheral portion of injection apertures of a fuel injection device 1E in accordance with Embodiment 5. In the aforementioned Embodiments 1 through 4, the circumferential groove (first circumferential groove) for forming drift flow in the injection apertures is formed on the outer surface of the needle valve 20 or the inner wall of the nozzle body 10. Embodiment 5 swirls fuel FE without using the circumferential groove. FIG. 8 shows the fuel injection device 1E in which the needle valve 20 is located at the low lift position, and FIG. 9 shows the fuel injection device 1E in which the needle valve 20 is located at the high lift position.

The fuel injection device 1E is designed so that a ring-shaped spacing SP functioning in a manner similar to that of the circumferential groove can be formed only when the needle valve 20 is located at the low lift position as shown in FIG. 8. As indicated by a reference circle CR, the spacing (gap) SP formed between the tip of the needle valve 20 and the nozzle body 10 swirls the fuel FE in a manner similar to that of the circumferential groove (first circumferential groove).

The needle valve 20 of Embodiment 5 has a column-shaped portion 30 at the tip thereof. The column-shaped portion 30 has a bottom surface slightly smaller than the bottom surface of an lower-end surface 20FP of the needle valve main body so as to allow the downward flow of the fuel FE guided by the guide grooves 22. That is, the circumferential portion of the low-end surface 20FP to which the column-shaped portion 30 is connected has a step portion 31. The step portion 31 is positioned so as to overlap the upper portions of the inlets 12NP of the injection apertures 12. A member 32 added to the end of the column-shaped portion 30 is a volume adjustment member for restraining the dead volume.

The upper portions of the inlets 12NP are shaped so as to easily receive the step portion 31. That is, the upstream side portions of the inlets 12NP are inclined so as to continue with the seat surface 11ST.

Turning to the reference circle CR in FIG. 8, the ring-shaped spacing SP is formed between the outer surface and the step portion 31 of the column-shaped portion 30 and the inner wall surface 11 of the nozzle body 10 including the peripheral portion of the inlets 12NP. The fuel FE flows into the spacing SP while swirl force is applied to the fuel FE by the guide grooves 22 located at the upper positions. The lower portions of the inlets 12NP are positioned so as to face the side surface of the column-shaped portion 30. It is thus difficult for the fuel FE to enter into the lower portions of the inlets 12NP. The ring-shaped spacing SP formed when the needle valve 20 is at the low lift position guides the fuel FE into the injection apertures 12 and generates drift flow as in the cases of Embodiments 1 through 4. At the time of low lift shown in FIG. 8, the fuel discharged from an outlet 12TP of the injection apertures 12 is brought into a state of diffusive spray of fine particles and a wide spray angle.

At the time of high lift shown in FIG. 9, the spacing between the needle valve 20 and the inner wall surface 11 becomes wider, and a larger amount of fuel FE flows into the inlets 12NP of the injection apertures 12 without constraint. In this case, the fuel FE in the injection apertures 12 flow to the outlets 12TP on the straight with little drift flow. Thus, the fuel discharged from the outlet 12TP of the injection apertures 12 has a column-shaped spray having a relatively small spray angle.

As described above, the fuel injection device 1E of Embodiment 5 provides effects similar to those of the fuel injection devices of Embodiments 1 through 4. Particularly, there is no need to form the circumferential groove on the needle valve 20 and the nozzle body 10, so that the number of production steps can be reduced and productivity can be improved. The guide grooves of the fuel injection device 1E may be formed on the inner wall surface 11 of the nozzle body 10.

### Embodiment 6

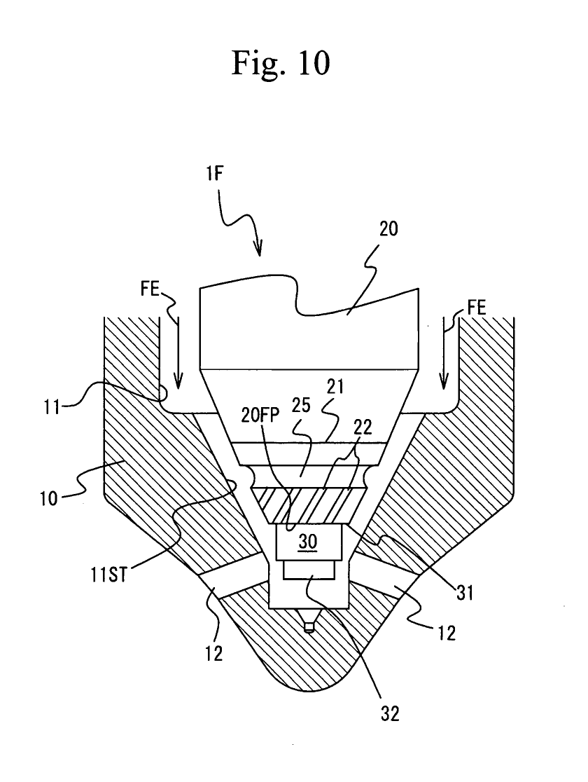

FIG. 10 is an enlarged view of a peripheral portion of injection apertures of a fuel injection device 1F in accordance with Embodiment 6. The fuel injection device 1F is configured by adding the circumferential groove (second circumferential groove) 25 for rectification to the needle valve 20 of the fuel injection device 1E of Embodiment 5. Like the fuel injection device 1C of Embodiment 3 shown in FIG. 6, the circumferential groove 25 is arranged at the upstream side of the guide grooves 22. Since the fuel injection device 1F is equipped with the circumferential groove 25 for rectification, the fuel FE can be efficiently guided to the guide grooves as compared to the fuel injection device 1E of Embodiment 5.

### Embodiment 7

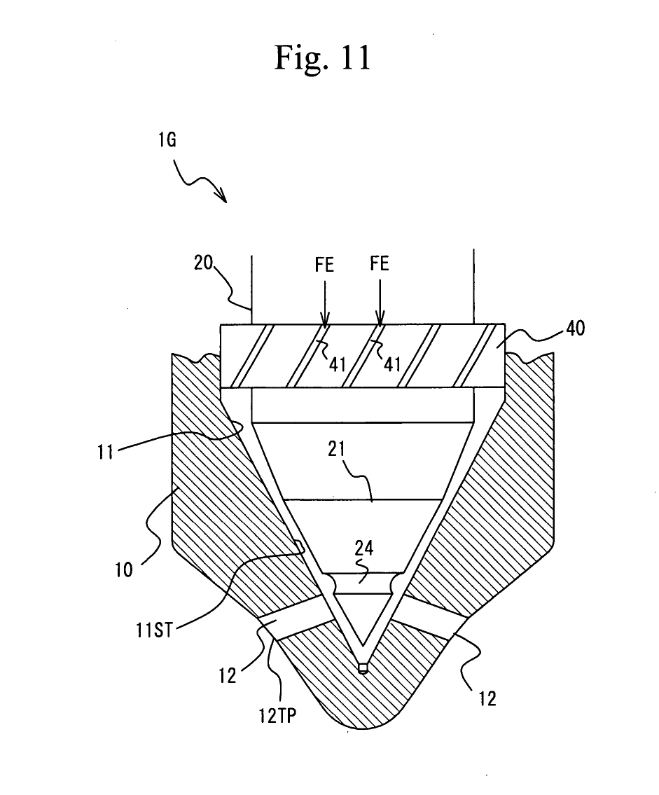

FIG. 11 is an enlarged view of a peripheral portion of injection apertures of a fuel injection device 10 in accordance with Embodiment 7. In the aforementioned Embodiments 1 through 6, the guide grooves for applying swirl force to fuel FE are formed on the needle valve 20 or the inner wall surface of the nozzle body 10. In contrast, the fuel injection device 1G uses a swirl flow forming member 40 of a ring shape (hereinafter referred to as swirl forming member 40) that may be a separate component. The swirl forming member 40 has multiple guide grooves 41 on its outer circumferential surface. The swirl forming member 40 may be joined to the inner wall surface of the nozzle body 10 by press fitting or to the outer circumferential surface of the needle valve 20 by welding or press fitting. FIG. 11 shows the needle valve 20 at the time of low lift. The circumferential groove 24 is formed at a position lower than the seat portion 21 like the aforementioned embodiments, and is partially overlapped with the upper portions of the injection apertures 12.

In the fuel injection device 1G, the fuel FE passing through the guide grooves 41 of the swirl forming member 40 flows down while being swirled along the inner wall surface 11 of the nozzle body 10, and enters into the circumferential groove 24. Then, the fuel FE is swirled in the circumferential groove 24. The following operation is the same as that of Embodiments 1 through 4. The fuel FE swirled flows into the injection apertures 12 so that drift flow can be caused, and a swirl flow of fuel FE is produced in the injection apertures 12. Thus, the fuel discharged from an outlet 12TP of the injection aperture 12 is brought into a state of diffusive spray of fine particles and a wide spray angle. In this manner, the fuel injection device 1A is capable of forming a spray shape of diffusive spray at the low lift position. The fuel injection device 1G is capable of changing the shape of sprayed fuel to column-shaped spray having a relatively small spray angle by merely moving the needle valve 20 from the low lift position to the high lift position. The fuel injection device 10 of Embodiment 7 utilizes the separate swirl forming member 40, so that the production process can be simplified and the cost can be reduced. Alternatively, the circumferential groove may be arranged so as to partially overlap with the upper portions of the injection apertures 12 of the nozzle body 10.

In Embodiments 1 through 6 mentioned above, the slant guide grooves 22 or 19 are provided on the outer circumferential surface of the needle valve 20 or the inner wall surface 11 of the nozzle body 10. Fuel is caused to flow into the circumferential groove 24 or the like through the guide grooves 22 or the like, and to be swirled therein. In order to produce a stronger swirl flow in the circumferential groove, a larger quantity of fuel may be vigorously entered into the guide grooves. In the aforementioned embodiments, there is some fuel that passes through the spacing between the outer circumference of the needle valve 20 and the inner wall surface of the nozzle body 10 without entering into the guide grooves. If such fuel passing rough the spacing is introduced into the guide grooves, stronger swirl flow can be produced in the circumferential groove. The following description is directed to a fuel injection device capable of introducing a larger quantity of fuel into the guide grooves.

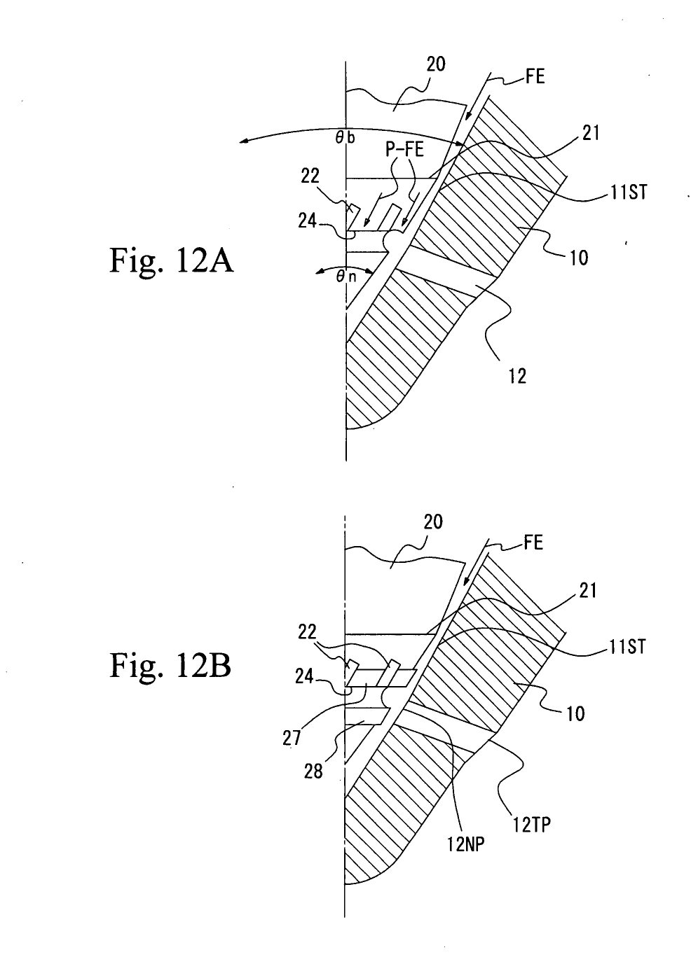

In order to facilitate easy understanding, a description will now be given, with reference to FIGS. 12(A) and 12(B), of differences between the aforementioned embodiments and the present embodiment. FIG. 12(A) shows the fuel injection device of the aforementioned embodiments, and FIG. 12(B) shows the present embodiment fuel injection device. As shown in FIG. 12(A), the angle (On) of the needle valve 20 closer to the tip than the seat portion 11ST is made greater than the conical angle (θb) of the seat surface of a conical shape formed on the nozzle body 10 in order to seal fuel FE when the needle valve 20 is seated. That is, the angular relationship θn>θb is defined. Thus, in the fuel injection device shown in FIG. 12(A), there is a spacing between the outer circumference of the needle body 20 and the inter wall surface of the nozzle body 10. Since the multiple guide grooves 22 are arranged at intervals, there is fuel P-FE passing through a spacing between the guide grooves 22. The fuel P-FE does not contribute formation of swirl flow in the circumferential groove 24.

The fuel injection device shown in FIG. 12(B) is equipped with a protrusion 27 on the upstream side of the circumferential groove 24, and a protrusion 28 on the downstream side. The protrusions 27 and 28 protrude from the circumferential surface of the needle valve having the conical tip in a ring-like formation. It is preferable to maximize the heights of the protrusions 27 and 28 (the thickness of the protrusions 27 and 28 from the outer circumference of the needle valve 20) as long as the protrusions 27 and 28 cause no trouble when the seat portion 21 of the needle valve 20 is seated on the seat surface 11ST of the nozzle body 10. In other words, the protrusions 27 and 28 are provided so as to just bury the spacing between the outer circumference of the needle valve 20 and the inner wall surface of the nozzle body 10.

The guide grooves 22 are formed so that only downstream-side portions or the entire guide grooves 22 engage the upstream-side protrusion 27. It is desired that the protrusion 27 faces the upper end of the circumferential groove 24. As shown, the protrusion 27 may be slightly shortened so that the downstream-side portions of the guide grooves 22 can be formed in the protrusion 27. Alternatively, the protrusion may be lengthened.

The protrusion 27 arranged on the upstream side of the circumferential groove 24 results in a state in which fuel flowing down is dammed when the needle valve 20 is at the low lift position. The dammed fuel FE concentrates on the guide grooves 22 that are cutoff portions on the protrusion 27. Thus, in the structure shown in FIG. 12(B), the quantity of fuel FE passing through the guide grooves 22 and the flow rate thereof are increased, as compared to the structure shown in FIG. 12(A). Thus, stronger swirl flow can be formed in the circumferential groove 24 located on the downstream sides of the guide grooves 22. This increases the quantity of fuel that enters into the upper portions of the inlets 12NP of the injection aperture 12 from the circumferential groove 24, and results in strong drift flows in the injection apertures 12. The drift flows cause swirl flows in the injection apertures, so that the fuel discharged from the outlet 12TP of the injection apertures 12 is brought into a state of diffusive spray of fine particles and a wide spray angle.

The protrusion 28 provided at the downstream side of the circumferential groove 24 restrains fuel entering into the circumferential groove 24 from flowing out of the groove 24 downwards. Although the protrusion 28 is preferably employed taking the above into consideration, but may be omitted. The protrusion 28 may be omitted in such a manner that a portion (lower portion) of the needle valve 20 closer to the tip than the circumferential groove 24 is enlarged so as to reduce the spacing and restrain the fuel from flowing out of the circumferential groove 24 downwards.

The fuel injection device shown in FIG. 12(B) operates in the same manner as the aforementioned embodiments when the needle valve 20 is located at the high lift position. That is, the spacing between the needle valve 20 and the inner wall surface 11 of the nozzle body 10 is widened, and much fuel FE flows into the inlets 12NP of the injection apertures 12 with little restriction. The fuel FE that has entered into the injection apertures 12 flows towards the outlet 12TP on the straight with little drift flow. Thus, the fuel discharged from the outlet 12TP of the injection apertures 12 has a column-shaped spray having a relatively small spray angle. Similar functions and effects to those of the exemplary structures in which the circumferential groove and the guide grooves are provided on the needle valve 20 as shown in FIGS. 12(A) and 12(B) may be obtained for a variation with the circumferential groove and the guide grooves formed on the inner wall surface 11 of the nozzle body 10. A concrete structure of the variation will now be described as an embodiment.

### Embodiment 8

### Embodiment 8

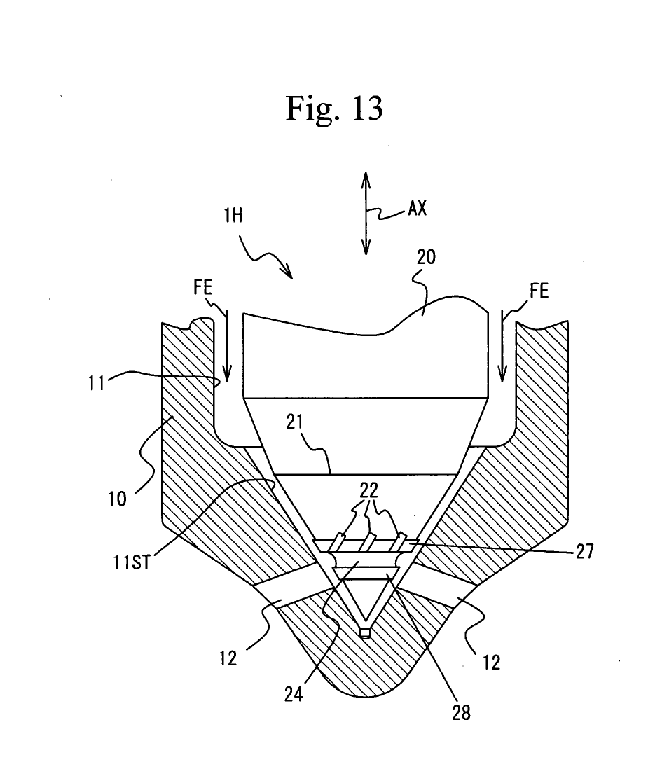

FIG. 13 is an enlarged view of a peripheral portion of injection apertures of a fuel injection device 1H in accordance with Embodiment 8. The fuel injection device 1H is configured by varying the fuel injection device 1A of Embodiment 1 so that the protrusions 27 and 28 are added to the upper and lower portions of the circumferential groove 24. The fuel injection device 1H is capable of supplying a large quantity of fuel at a high flow rate to the circumferential groove 24 via the guide grooves 22, as compared to the guide grooves 22. Thus, stronger swirl flow can be formed in the circumferential groove 24. As has been described previously, the protrusion 27 is arranged in a ring-like formation so as to face the upper end of the circumferential groove 24. The guide grooves 22 may be varied so as to be partially formed in the protrusion 27. Alternatively, the entire guide grooves 27 may be formed in the protrusion 27.

### Embodiment 9

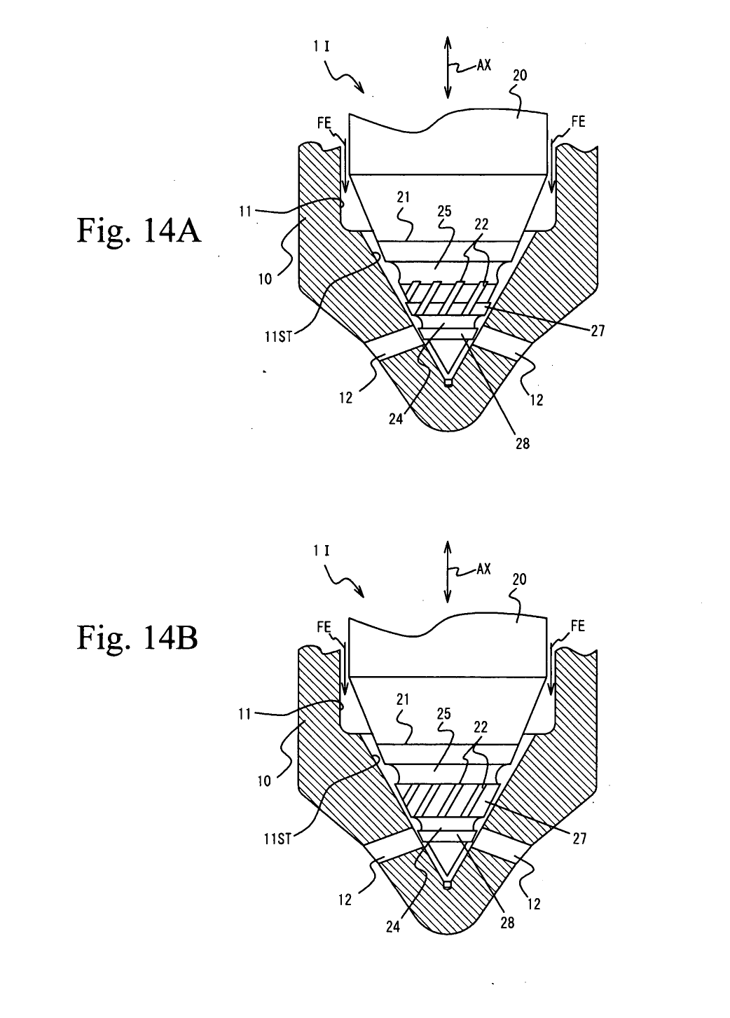

FIGS. 14A and 14B are enlarged views of a peripheral portion of injection apertures of a fuel injection device 1I in accordance with Embodiment 9. The fuel injection device 1I is configured by varying the fuel injection device 1C of Embodiment 3 so that the protrusions 27 and 28 are added to the upper and lower portions of the circumferential groove 24. FIG. 14(A) shows an arrangement in which the protrusion 27 is partially formed between the first circumferential groove 24 and the second circumferential groove 25. FIG. 14(B) shows another arrangement in which the protrusion 27 is fully formed between the first circumferential groove 24 and the second circumferential groove 25. The fuel injection device 11 is capable of forming strong swirl flow in the circumferential groove 24, as compared to the fuel injection device 1C.

### Embodiment 10

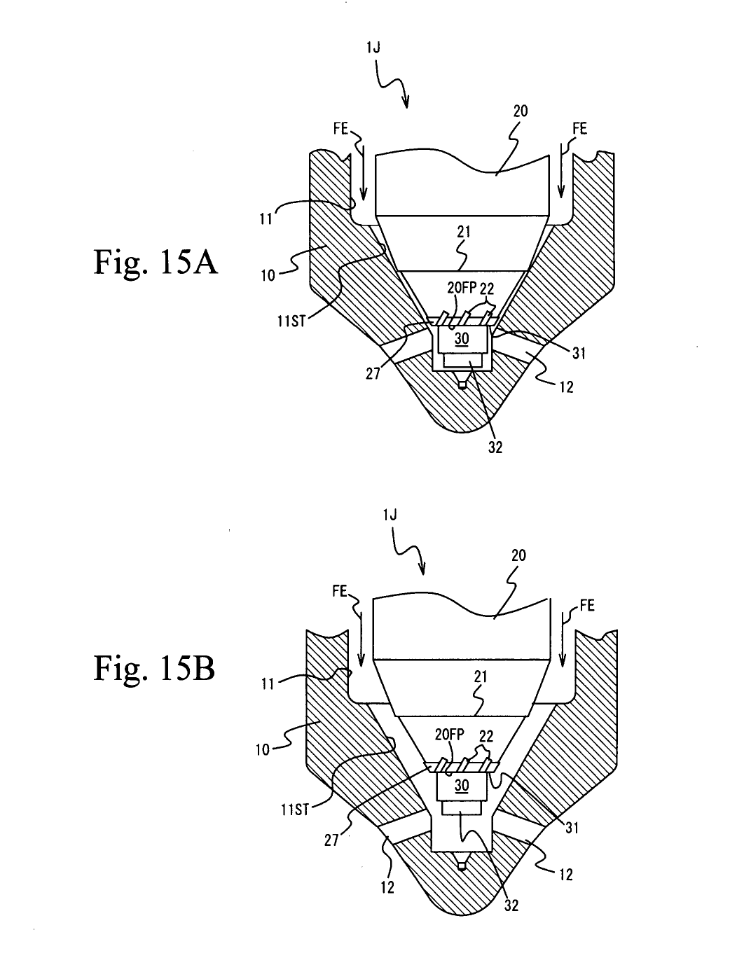

FIGS. 15(A) and 15(B) are enlarged views of a peripheral portion of injection apertures of a fuel injection device 1J in accordance with Embodiment 10. The fuel injection device 1J is configured by varying the fuel injection device 1E having the column-shaped portion 30 at the tip of the needle valve 20 in Embodiment 5. The needle valve 20 has the step portion 31 on the circumference of the lower end surface 20FP to which the column-shaped portion 30 is connected. The fuel injection device 1J of the present embodiment has the protrusion 27 added to the step portion 31. FIG. 15(A) shows a state of the fuel injection device 1J when the needle valve 20 is at the low lift position. FIG. 15(B) shows another state of the fuel injection device 1J when the needle valve 20 is at the high lift position. As compared to the fuel injection device 1E, the present fuel injection device 1J is capable of forming strong swirl flow due to the ring-shaped spacing formed between the outer circumference of the column-shaped portion 30 and the nozzle body 10 when the needle valve 20 is at the low lift position. The entire guide grooves 22 may be formed in the protrusion 27, or only parts of the guide grooves 22 may be formed therein.

### Embodiment 11

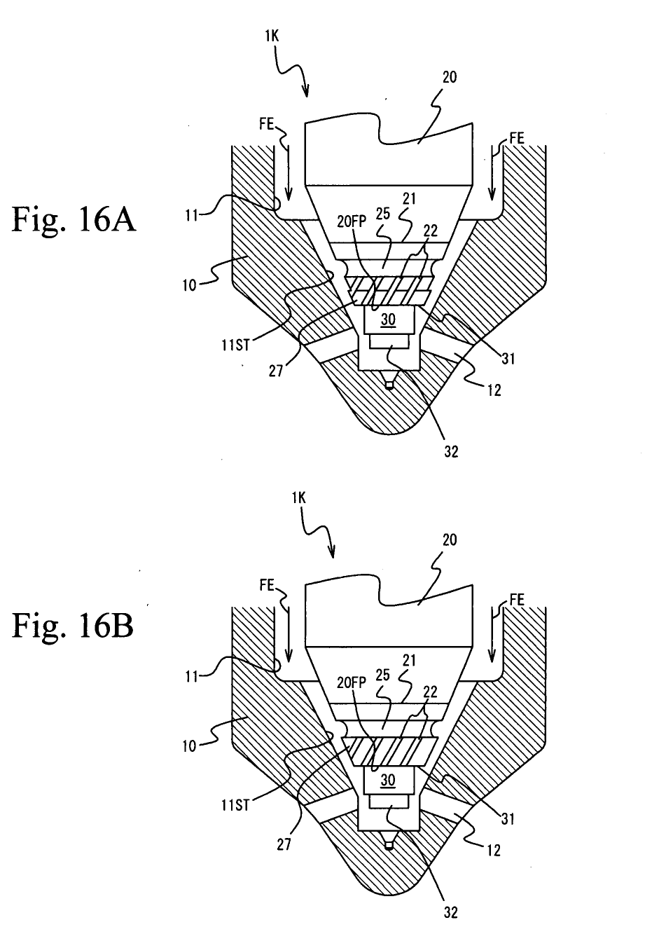

FIGS. 16(A) and 16(B) are enlarged views of a peripheral portion of injection apertures of a fuel injection device 1K in accordance with Embodiment 11. The fuel injection device 1K is configured by varying the fuel injection device 1F of Embodiment 6. The needle valve 20 with the column-shaped portion 30 has the circumferential groove (second circumferential groove) 25 for rectification at the upper ends of the guide grooves 22. The present fuel injection device 1K has the protrusion 27 in the region in which the guide grooves 22 are formed. FIG. 16(A) shows an arrangement in which the protrusion 27 is formed in a part of the region in which the guide grooves 22 exist, and FIG. 16(B) shows another arrangement in which the protrusion 27 is formed in the entire region in which the guide grooves 22 exist. As compared to the fuel injection device 1F, the present fuel injection device 1K is capable of forming strong swirl flow due to the ring-shaped spacing formed between the outer circumference of the column-shaped portion 30 and the nozzle body 10 when the needle valve 20 is at the low lift position.

### Embodiment 12

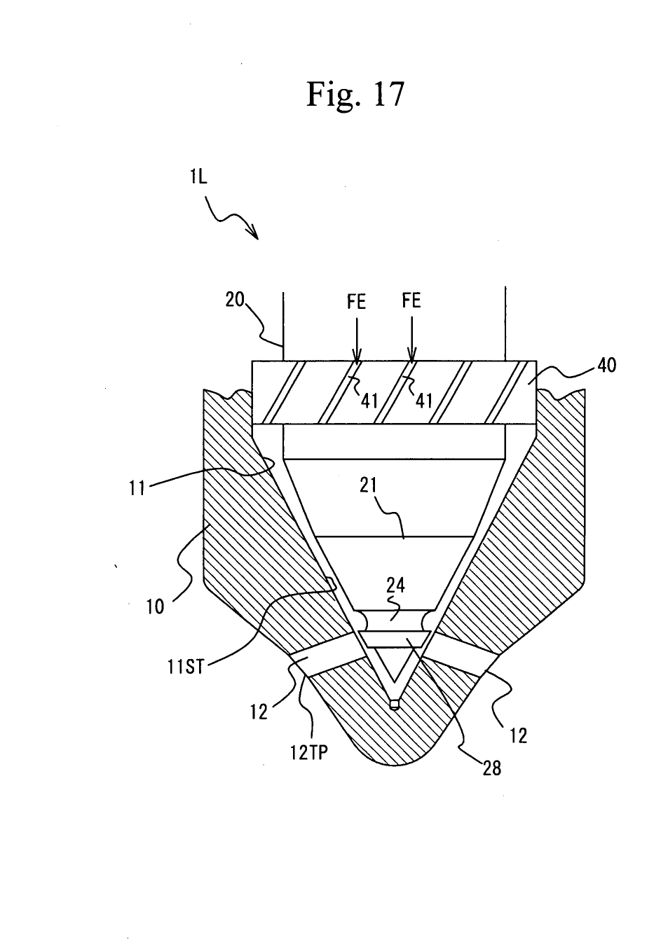

FIG. 17 is an enlarged view of a peripheral portion of injection apertures of a fuel injection device 1L in accordance with Embodiment 12. The fuel injection device 1L is configured by varying the fuel injection device 1G of Embodiment 7 so that the protrusion 28 is added below the circumferential groove 24. The fuel injection device 1L is capable of suppressing fuel entering in the circumferential groove 24 from flowing down, and is therefore capable of forming strong swirl flow in the circumferential groove 24, as compared to the fuel injection device 1G.

The fuel injection devices of the aforementioned embodiments can change the shape of sprayed fuel by changing the lift amount of the needle valve 20. When the axial position of the the needle valve 20 is fixed to the low lift position, the fuel injection device permanently forms diffusive spray. The fuel injection device of permanent diffusive spray type may be applied to direct injection type gasoline engines.

(Variation 1)

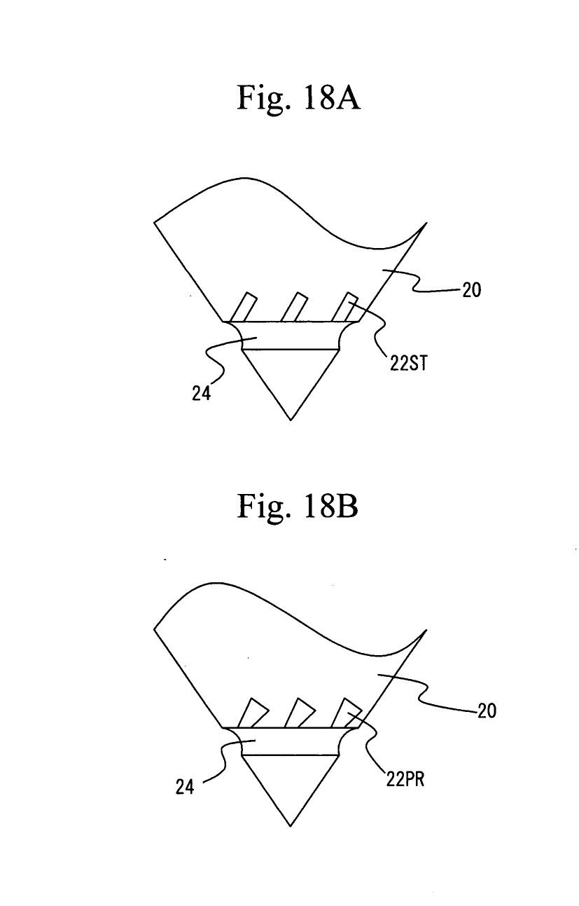

A description will now be given of a variation applicable to the aforementioned embodiments. FIGS. 18(A) and 18(B) show variations of the guide grooves 22 provided on the needle valve 20. FIG. 18(A) shows guide grooves 22ST of a standard stripe shape. In contrast, FIG. 18(B) shows guide grooves 22PR having an approximately trapezoidal shape in which the groove width on the fuel FE inlet side (upstream side) is greater than that on the fuel FE outlet side (the side connected to the circumferential groove 24). A tapered shape of the guide grooves 22PR is more likely to gather fuel FE and efficiently introduce the fuel FE to the circumferential groove 24. Further, the tapered shape enhances the flow rate at which the fuel FE goes out.

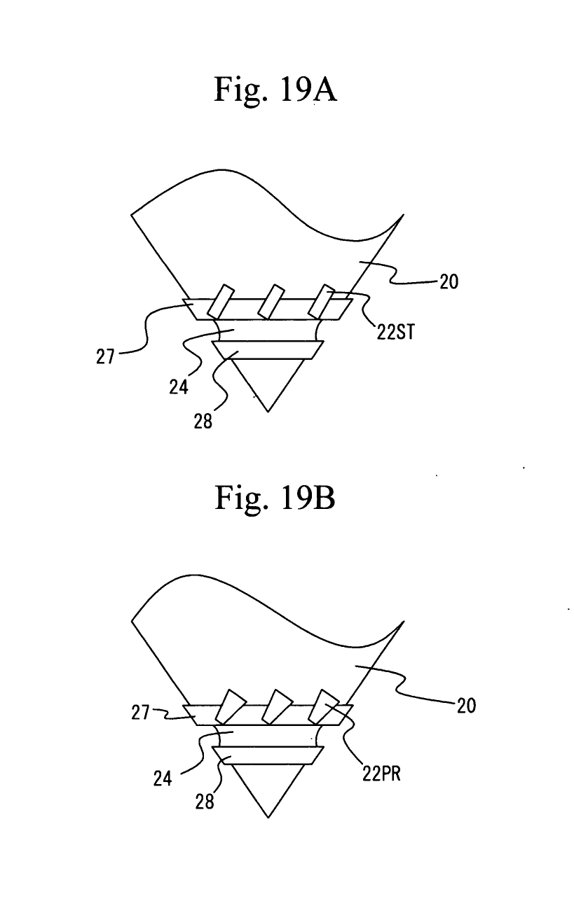

In FIGS. 18(A) and 18(B), the depth of the guide grooves 22ST and 22PR may be varied so that the depth on the fuel FE inlet side is deeper than that on the fuel FE outlet side. This variation enhances the flow rate at which the fuel FE goes out. Although FIGS. 18(A) and 18(B) are directed to the guide grooves 22 provided on the needle valve 20, the variation shown therein may be applied to the guide grooves 19 provided on the nozzle body 10 as well. As shown in FIGS. 19(A) and 19(B), when the protrusions 27 and 28 are added to the upper and lower portions of the circumferential groove 24, the flow rate at which the fuel FE that goes out can be enhanced for both the cases of FIGS. 19(A) and 19(B). The case shown in FIG. 19(A) employs the guide grooves 22ST having the standard stripe shape, and the case shown in FIG. 19(B) employs the guide grooves 22PR having a trapezoidal shape.

(Variation 2)

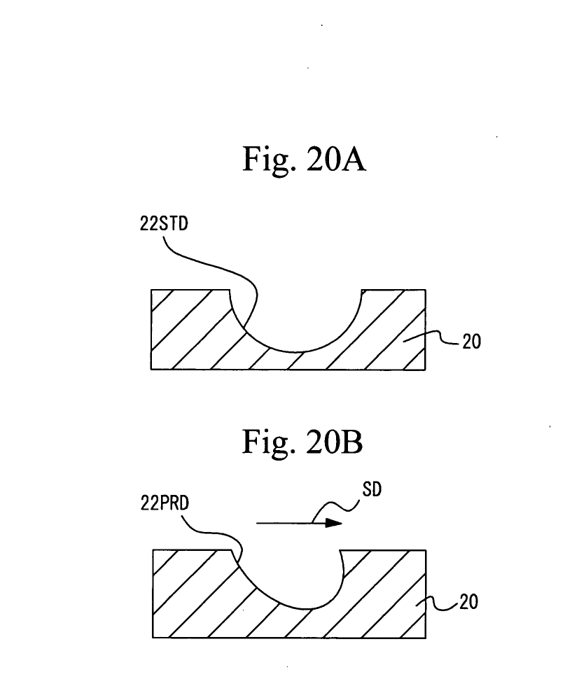

FIGS. 20(A) and 20(B) show variations of the cross sections of the guide grooves 22 provided on the needle valve 20. FIG. 20(A) shows a guide groove 22STD having a standard arc shape. In contrast, FIG. 20(B) shows a guide groove 22PRD in which the depth gradually increases from the upstream side to the downstream side in a fuel swirl direction SD. The above shape of the guide grooves 22PRD is more likely to gather fuel FE and efficiently introduce the fuel FE to the circumferential groove 24. Further, the shape enhances the flow rate at which the fuel FE goes out. The guide grooves 22 is not limited to the arc-shaped cross section shown in FIG. 13 but may be a V-shaped or C-shaped cross section. Although FIGS. 20(A) and 20(B) are directed to the guide grooves 22 provided on the needle valve 20, the variation shown therein may be applied to the guide grooves 19 provided on the nozzle body 10 as well.

(Variation 3)

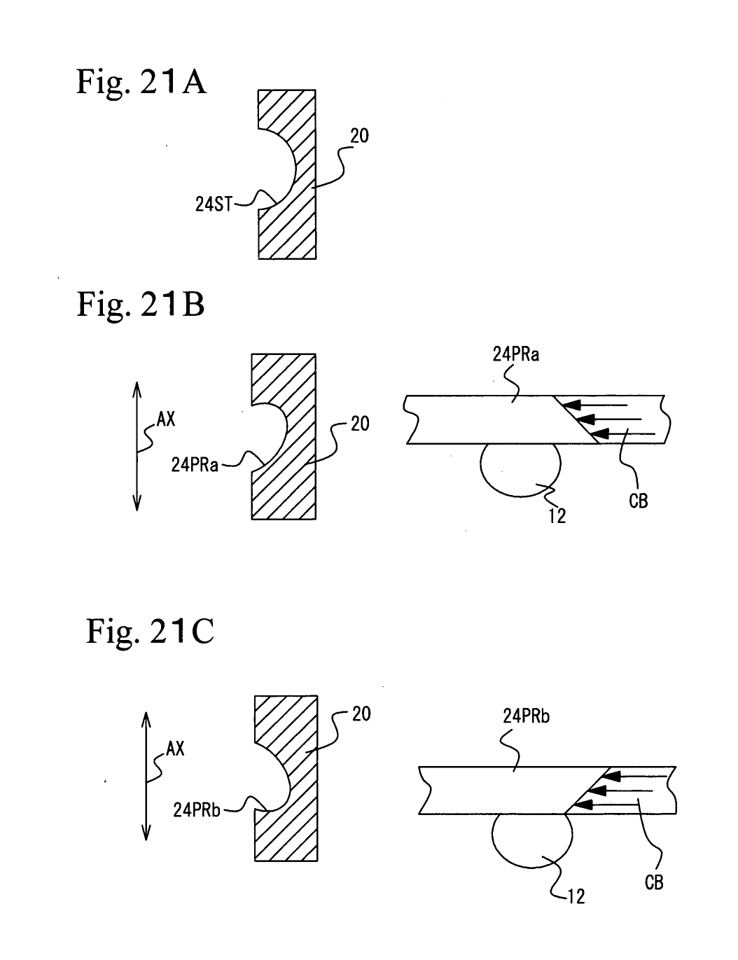

FIGS. 21(A), 21(B) and 21(C) show variations of the cross section of the circumferential groove 24 provided on the needle valve 20. FIG. 21(A) shows a circumferential groove 24ST having a standard arc shape. FIG. 21(B) shows a circumferential groove 24PRa in which the cross section taken along an axial direction AX of the needle valve has a depth that gradually increases from the tip of the needle valve to the root end thereof. FIG. 21(C) shows a circumferential groove 24PRb in which the cross section taken along the axial direction AX of the needle valve has a depth that gradually increases from the root end of the needle valve to the tip end thereof.

The deeper the groove, the greater the flow rate of fuel FE therein. FIGS. 21(B) and 21(C) show flow rate distributions CB in the circumferential grooves on the right-hand sides. In the structure shown in FIG. 21(B) in which the groove is deeper on the root end side, the flow rate in the upper portion of the groove is greater than that in the lower portion. In this distribution, drift flow occurs over a wide range of overlapping with the injection apertures 12 when the fuel enters into the injection apertures 12. In contrast, in the structure shown in FIG. 21(C) in which the groove is deeper on the tip side, the flow rate in the lower portion of the groove is greater than that in the upper portion. In this distribution, drift flow occurs over a narrow range of overlapping with the injection apertures 12 when the fuel enters into the injection apertures 12, and diffusive spray can be carried out in the narrow lift range.

As described above, the shape of sprayed fuel can be controlled by changing the cross section of the circumferential groove. The circumferential groove is not limited to the arc shape cross sections shown in FIGS. 21(A) through 21(C), but may have a V-shaped cross section or a C-shaped cross section. Although FIGS. 21(A) through 21(C) are directed to the circumferential groove 24 provided on the needle valve 20, the present variation may be applied to the guide grooves 19 provided on the nozzle body 10.

In Embodiment 8 and the other embodiments subsequent thereto, the protrusion is added to the needle valve 20. When the guide grooves 19 are provided to the inner wall surface 11 of the nozzle body 10, a similar protrusion may be applied to the nozzle body 10.

The preferred embodiments of the present invention have been described. The present invention is not limited to these specific embodiments, but variations and modifications may be made within the scope of the claimed invention.

1. A fuel injection device characterized by comprising a nozzle body equipped with multiple injection apertures, a needle valve arranged in the nozzle body, a fuel swirl portion in which fuel is swirled along an inner wall surface of the nozzle body, and a guide portion applying swirl force to the fuel and then guiding the fuel to the fuel swirl portion, the fuel swirl portion being arranged at a position at which the fuel swirl portion partially overlaps with the injection apertures.

2. The fuel injection device as claimed in claim 1, characterized in that the fuel swirl portion includes a first circumferential groove formed on one of the inner wall surface of the nozzle body and an outer circumferential surface of the needle valve.

3. The fuel injection device as claimed in claim 1, characterized in that the guide portion includes a groove formed on one of the inner wall surface of the nozzle body and an outer circumferential surface of the needle valve.

4. The fuel injection device as claimed in claim 2, characterized in that a protrusion is provided at an upstream side of the circumferential groove, and the guide grooves are formed in the protrusion.

5. The fuel injection device as claimed in claim 4, characterized in that another protrusion is provided at a downstream side of the circumferential groove.

6. The fuel injection device as claimed in claim 2, characterized by further comprising a needle movement mechanism that moves the needle valve in its axial direction to thus change a lift amount of the needle valve, wherein:
the needle valve is movable between a low lift position having a small lift amount and a high lift position having a large lift amount by the needle movement mechanism; and
the first circumferential groove overlaps with parts of injection apertures when the needle valve is located at the low lift position.

7. The fuel injection device as claimed in claim 1, characterized in that the fuel swirl portion includes a ring-shaped s pacing formed between an outer circumferential surface of the needle valve and the inner wall surface of the nozzle body.

8. The fuel injection device as claimed in claim 7, characterized in that the guide portion includes a groove formed on one of the inner wall surface of the nozzle body and the outer circumferential surface of the needle valve.

9. The fuel injection device as claimed in claim 7, characterized by further comprising a needle movement mechanism that moves the needle valve in its axial direction to thus change a lift amount of the needle valve, wherein:
the needle valve is movable between a low lift position having a small lift amount and a high lift position having a large lift amount by the needle movement mechanism; and
a ring-shaped spacing is defined when the needle valve is at the low lift position.

10. The fuel injection device as claimed in claim 7, characterized in that the needle valve has a column-shaped portion having a small size at a tip, and the ring-shaped spacing is defined between the outer circumferential surface of the column-shaped portion and the inner wall surface of the nozzle body when the needle valve is at the low lift position.

11. The fuel injection device as claimed in claim 10, characterized in that there is provided a protrusion at an upstream side of the column-shaped portion, and a groove included in the guide portion is formed in the protrusion.

12. The fuel injection device as claimed in claim 1, characterized in that a second circumferential groove for rectification is connected to an upstream side of the guide portion.

13. The fuel injection device as claimed in claim 1, characterized by further comprising a swirl flow forming member spaced apart from the fuel swirl portion, wherein the swirl flow forming member has the guide portion.

14. The fuel injection device as claimed in claim 13, characterized in that the fuel swirl portion is a first circumferential groove formed on one of the inner wall surface of the nozzle body and an outer circumferential surface of the needle valve.

15. The fuel injection device as claimed in claim 14, further comprising a protrusion at a downstream side of the first circumferential groove.

16. The fuel injection device as claimed in claim 14, characterized by further comprising a needle movement mechanism that moves the needle valve in its axial direction to thus change a lift amount of the needle valve, wherein:
the needle valve is movable between a low lift position having a small lift amount and a high lift position having a large lift amount by the needle movement mechanism; and
the first circumferential groove overlaps with parts of injection apertures when the needle valve is located at the low lift position.

17. The fuel injection device as claimed in claim 1, characterized in that the guide portion includes a groove, which includes a groove width at a fuel inlet side greater than a groove width at a fuel outlet side.

18. The fuel injection device as claimed in claim 1, characterized in that the guide portion includes a groove, which gradually becomes deeper from an upstream side in a fuel swirl direction to a downstream side.

19. The fuel injection device as claimed in claim 2, characterized in that the first circumferential groove has a cross section taken along an axial line of the needle valve so that the cross section has a depth that gradually increases from a tip of the needle valve to a root end of the needle valve.

20. The fuel injection device as claimed in claim 2, characterized in that the first circumferential groove has a cross section taken along an axial line of the needle valve so that the cross section has a depth that gradually increases from a root end of the needle valve to a tip of the needle valve.

21. The fuel injection device as claimed in claim 1, characterized in that the fuel swirl portion is formed so as to overlap with ½ to ⅓ of the injection apertures on upper sides thereof.
